(19) United States
(12) Patent Application Publication
(10) Pub. No.: US 2026/0219830 A1
(43) Pub. Date: Jul. 30, 2026

(54) PROXIMITY-BASED AUDIO CONFERENCING

(71) Applicant: Koninklijke KPN N.V., Rotterdam (NL)

(72) Inventor: Hans Maarten Stokking, Wateringen (NL)

(21) Appl. No.: 19/151,910

(22) PCT Filed: Jan. 9, 2024
(86) PCT No.: PCT/EP2024/050400

§ 371 Date: Jul. 29, 2025

(30) Foreign Application Priority Data
Feb. 3, 2023 (EP) 23154926.2

(51) Int. Cl. G06F 3/16; H04L 12/18

(52) U.S. Cl. CPC G06F 3/165; G06F 3/162; H04L 12/1822

(57) ABSTRACT

A method of facilitating audio conferencing comprises predicting or determining whether a first user (76) of a first user device (71) is able to hear a second user (77) of a second user device (72) directly and enabling the first user device to reproduce audio captured by the second user device while the first user device reproduces audio captured by a third user device (73) if the first user is predicted or determined not to be able to hear the second user directly or preventing that the first user device reproduces audio captured by the second user device while the first user device reproduces audio captured by the third user device if the first user is predicted or determined to be able to hear the second user directly.

### FIELD OF THE INVENTION

The invention relates to an audio conferencing facilitating device and to an audio conferencing system comprising such an audio conferencing facilitating device.

The invention further relates to a method of facilitating audio conferencing.

The invention also relates to computer program products enabling a computer system to perform such a method.

### BACKGROUND OF THE INVENTION

Regular multi-user audio conferencing, optionally with video, is still very popular in business environments. For multi-user Augmented Reality (AR) applications, usually no audio conferencing is offered. Most such AR applications focus on multiple users in close physical proximity, looking at the same virtual objects. Such users are thus capable of communicating directly (in the physical environment), without the help of any audio conferencing facilitating devices.

For example, a group of museum visitors may use such a multi-user Augmented Reality application. Such a group (of at least two persons) is often together, but may also fan out, where people go their own way. For these people, it is hard to stay in contact with each other in such a situation, often saying “let's meet there and there in one hour” or calling or texting each other to find one another again. Similar group situations may occur at work, at outdoor events, at school, etc. Such use cases could become more and more commonplace, as many users, especially younger generations, often wear earbuds all day long. An audio conferencing system can be a great help here, allowing for communication between users even when physically apart. But such a system is great when physically apart, but at best unnecessary when physically together.

Ideally, users can talk to each other naturally, without having to think about where the other users of the group currently are, and without manual muting/unmuting, sharing microphones, calling each other while putting smartphones on speakerphone mode to share the call with someone else, starting and ending calls, using push-to-talk, etc. Using such methods may well enable communication between the users of the group, but this puts the burden on the members of the group to figure out how to communicate well given the current location of every member of the group. Such group communication should work even in the worst case scenarios, where some users in the group are physically within talking distance while others are at unknown locations.

A problem that occurs in the situation when audio conferencing is working with multiple locally physically present users is that these users may hear each other double: once direct through the air and once through the audio conferencing system. This gives a very uncomfortable echo, as the audio conferencing system's audio will likely be delayed at least 100-150 milliseconds, whereas the direct audio only suffers from the negligible through-the-air delay. Even when noise cancelling headphones are used to cancel out the direct audio and this is done perfectly, this will still not result in a good user experience, as the audio will be delayed through the system while people see each other directly and then no lip-sync will be achieved.

This problem also exists in business environments when a conferencing speaker system, which includes one or more speakers and one or more microphones, is used. Certain conferencing systems including applications such as Zoom Rooms and Microsoft Teams Rooms offer the possibility of using proximity detection to mute participants' microphones and speakers when they are in or coming into a room with a room conferencing speaker system that is in the same conference. This prevents echo/crosstalk. However, this solution is not applicable when multiple users are near each other but not near such a conferencing speaker system, e.g. if no conferencing speaker systems are used.

### SUMMARY OF THE INVENTION

It is a first objective of the invention to provide a system, which is able to facilitate audio conferencing without annoying echo and with good lip-sync even when multiple users are near each other but not near a conferencing speaker system.

It is a second objective of the invention to provide a method, which can be used to facilitate audio conferencing without annoying echo and with good lip-sync even when multiple users are near each other but not near a conferencing speaker system.

In a first aspect of the invention, an audio conferencing facilitating device comprises at least one processor that may be configured to predict or determine whether a first user of a first user device is able to hear a second user of a second user device directly, and may enable the first user device to reproduce audio captured by the second user device while the first user device reproduces audio captured by a third user device if the first user is predicted or determined not to be able to hear the second user directly or may prevent that the first user device reproduces audio captured by the second user device while the first user device reproduces audio captured by the third user device if the first user is predicted or determined to be able to hear the second user directly.

The first user device and the second user device form an audio conferencing system. The audio conferencing system may further comprise a central audio system, e.g. a conferencing server. The audio conferencing facilitating device may be, for example, such a user device or such a central audio system. The audio conferencing facilitating device does not need to be an audio conferencing device. For example, the audio conferencing facilitating device may only perform group management and control audio conferencing devices, e.g. as part of an AR service, while not receiving any audio packets itself. Audio conferencing may include any form of real-time audio communication, including regular audio conferencing, multi-party telephony, real-time push-to-talk services, group audio communication as part of multiplayer games, for example. The first user device and the second user device are preferably single user devices.

By selectively reproducing the audio captured by the second user device on the first user device, i.e. by not reproducing the audio captured by the second user device on the first user device (but still reproducing the audio captured by one or more other user devices on the first user device) if the first user of the first user device is predicted to be able to hear the second user of the second user device, it is prevented that the first user hears the second user double, i.e. once directly through the air and once through the audio conferencing system. In this situation, the second user device preferably does not reproduce audio captured by the first user device either. The use of such an audio conferencing facilitating device results in an audio conferencing system that provides a good user experience, i.e. no annoying echo and good lip-sync, even when multiple users are near each other but not near a single conferencing speaker system.

For example, a room conferencing speaker system is not practical in museum environments, e.g. because there needs to be a sufficient number of room conferencing speaker systems to cater for each group of visitors, the use of such a room conferencing speaker system may disturb other visitors, and such room conferencing speaker systems are normally placed and installed at fixed locations. The best results for such a museum environment may be obtained if the first and second users are wearing headphones/earphones that allow environmental audio through. The audio conferencing facilitating device and the audio conferencing system may additionally support video conferencing and/or augmented reality.

A conferencing facilitating device may be any kind of device that facilitates a conference. These include user devices, such as devices used for capture of user audio or video, devices used for rendering of user audio or video, user devices used for session setup and control of audio and video management, i.e. capture, processing, transmission, rendering of audio and video, user devices used for group management or floor control, etc. These are typically, but not limited to, smartphones, laptops, computers, AR and VR headsets, headphones, Bluetooth or other types of wireless or wired conferencing headsets or speakers, room conferencing systems, game consoles, handheld gaming devices. These also include central components or devices that play some role in a conference, including but not limited to conferencing servers, stream forwarding units, multipoint control units, network based stream processors, rendezvous servers, echo cancellers, session border controllers, signaling servers, register servers, etc. As is known, many such servers and central components are implemented as software and run on generic hardware, often on cloud platforms or other distributed computing platforms. Such software that is running on more generic hardware is also considered a ‘conferencing facilitating device’ in so far it is actually implementing the functionality or software that plays a role in any part of the conference.

The audio conferencing facilitating device may be the first user device, for example. For example the at least one processor may be configured to prevent that the first user device reproduces audio captured by the second user device by adjusting its processing of received audio packets such that the audio captured by the second user device is not reproduced. For instance, the at least one processor of the first user device may simply skip an audio reproduction step in which the audio captured by the second user device is reproduced, or set the volume to zero for that specific audio, or replace the incoming audio packets received from the second user device with silent packets, if the first user of the first user device is predicted to be able to hear the second user of the second user device directly.

Alternatively, the audio conferencing facilitating device may be the second user device or a central audio system, for example. For instance, the at least one processor may be configured to prevent that the first user device reproduces audio captured by the second user device by sending an instruction over a network to the first user device, the instruction instructing the first user device not to reproduce audio captured by the second user device. In this case, an audio stream with the audio captured by the second user device would still be transmitted by the second user device and may still be received by the first user device, either peer-to-peer or forwarded by the central audio system. This is beneficial if the first user device would not work properly when it would not receive any audio stream belonging to the second user (device). This instruction may be provided in a signal or in metadata associated with the transmitted audio stream.

Alternatively, the at least one processor may be configured to prevent that the first user device reproduces audio captured by the second user device by not transmitting audio captured by the second user device to the first user device. In this case, the central audio device may be a stream forwarding unit. Either no audio stream captured by the second user device is transmitted or the audio captured by the second user device is replaced with silence in the transmitted audio stream. The former has the benefit of reducing the consumed bandwidth the most. The latter has the benefit that the first user device may be a conventional user device.

The audio conferencing facilitating device may be the central audio system and the at least one processor may be configured to mix audio captured by multiple devices in a single stream customized for the first user device and transmit the single stream to the first user device. In other words, the central audio device may be a multipoint control unit. The use of such a multipoint control unit reduces the bandwidth needed on the link to the first user device. The at least one processor may be configured to prevent that the first user device reproduces audio captured by the second user device by omitting the audio captured by the second user device from the single stream transmitted to the first user device.

If the audio conferencing facilitating device is the first user device, the at least one processor may be configured to prevent that the first user device reproduces audio captured by the second user device by instructing a central audio system or the second user device to prevent that the first user device reproduces audio captured by the second user device. Thus, it is the first user device which predicts whether the first user is able to hear the second user directly, e.g. based on proximity and/or location data, but the first user device's behavior does not depend on this prediction directly. The central audio system may be a stream forwarding unit or a multipoint control unit as described above.

If the audio conferencing facilitating device is the second user device, the at least one processor may be configured to prevent that the first user device reproduces audio captured by the second user device by instructing a central audio system to prevent that the first user device reproduces audio captured by the second user device.

The at least one processor may be configured to receive audio captured by a third user device, determine whether the audio captured by the third user device comprises first audio information originating from a same source as second audio information comprised in the audio captured by the second user device, and remove the second audio information from the audio captured by the second user device or remove the first audio information from the audio captured by the third user device if the first audio information and the second audio information are determined to originate from the same source.

This solves the problem that may occur if the same (sound-producing) source, e.g. a user, is captured through multiple microphones at the same time, which is also referred to as the dual-capture problem in the specification. In this case, a remote user may hear each of multiple nearby users twice. This may cause problems if the delay through one user's device is different from delay through another user's device. If the delays are (roughly) the same, the audio that is captured double is overlapping during playout, and no strange effects occur. Removing audio information may comprise audio processing such as cancelling the audio information in the captured audio or subtracting the audio information from the captured audio. This cancellation/subtraction typically uses comparable techniques as (regular) echo cancellation,

Determining whether first audio information and second audio information originate from the same source may also be used in an audio conferencing facilitating device if the audio conferencing facilitating device is a central audio system to predict whether a first user of a first user device is able to hear a second user of a second user device directly, in which case the user devices do not have to be modified.

Alternatively, the at least one processor may be configured to deactivate either capturing and/or transmission of audio by the first user device or capturing and/or transmission of audio by the second user device if the audio captured by the first user device and the audio captured by the second user device are determined or expected to comprise audio information from the same source. This is another solution to the problem that may occur if the same (sound-producing) source, e.g. a user, is captured through multiple microphones at the same time, i.e. another solution to the dual-capture problem. By deactivating only the transmission and not the capturing, the captured audio may still be analyzed. For example, transmission of the audio by the first user device or the second user device may be activated again if the audio captured by the first user device and the audio captured by the second user device are no longer determined or expected to comprise audio information from the same source.

The audio captured by the first user device and the audio captured by the second user device may be expected to comprise audio information from the same source if the first user of the first user device is predicted to be able to hear the second user of the second user device directly, for example. As an extension to this, the audio captured in this manner may be normalized, i.e. ensuring the volume of both or all speaking users is roughly the same, by for example increasing the volume of voices to the highest detected speaking volume. This may be used to ensure that the user of the device of which the capturing and/or transmission of audio is deactivated can be heard equally well as the user of the (nearby) device of which the capturing and/or transmission of audio is not deactivated.

A process of analyzing the audio captured by the first user device and the audio captured by the second user device to determine or predict whether they comprise audio information from the same source, i.e. audio pattern detection, may be continuously performed or may be started upon detecting a certain event. This event may be the detection of a certain user identified speaking in both audio streams based on voice pattern recognition or the prediction that the first user is able to hear the second user directly, for example.

This solution to the dual-capture problem may also be used in an audio conferencing facilitating device which does not prevent that the first user device reproduces audio captured by the second user device if the first user is predicted to be able to hear the second user directly, and even in an audio conferencing facilitating device which does not predict whether a first user of a first user device is able to hear a second user of a second user device directly but determines or predicts in a different way whether the audio captured by the first user device and the audio captured by the second user device comprises audio information from the same source.

The at least one processor may be configured to obtain proximity and/or location data, the proximity and/or location data being indicative of a proximity of the first user device to at least the second user device and/or indicative of at least a location of the first user device and a location of the second user device, and predict based on the proximity and/or location data whether the first user of the first user device is able to hear the second user of the second user device directly.

As a first example, the at least one processor may be configured to obtain the proximity and/or location data by receiving at least part of the proximity and/or location data from one or more further devices. As a second example, the audio conferencing facilitating device may further comprise at least one sensor and the at least one processor may be configured to obtain sensor information via the at least one sensor and obtain the proximity and/or location data by determining at least part of the proximity and/or location data based on the sensor information.

Proximity may be determined in different ways. Proximity may be determined using a wireless probe signal, for example the second user device transmitting an RF (e.g. Bluetooth or Wi-Fi), (ultra) sound, or infrared signal, and the first user device in the same time interval receiving that signal, i.e. listening for that signal and determine whether it is received and received with sufficient strength to be in proximity.

Predicting whether the first user is able to hear the second user directly may involve applying an audio volume threshold, which may be dependent on whether users wear headphones/earphones and if so whether they allow environmental audio through, whether hear-through functionality is enabled or environmental noise suppression functionality activated etc. A threshold may additionally or alternatively depend on the environment, e.g. a lower threshold for an environment such as a conference room, and a higher threshold for an environment where more background noise is present, other people talking, music playing etc.

In a second aspect of the invention, an audio conferencing system comprises the audio conferencing facilitating device. If the audio conferencing facilitating device is a central audio system, the audio conferencing system may further comprise the first user device, the second user device, and the third user device. If the audio conferencing facilitating device is one of the first user device and the second user device, the audio conferencing system may further comprise the other one of the first user device and the second user device and further comprises the third user device.

The at least one processor of the audio conferencing device or at least one further processor of the audio conferencing system may be configured to predict or determine whether the first user of the first user device is able to hear a third user of the third user device directly, and if the first user is predicted or determined not to be able to hear the third user directly, may enable the first user device to reproduce audio captured by the second user device and audio captured by the third user device if the first user is predicted or determined not to be able to hear the second user directly or may prevent that the first user device reproduces audio captured by the second user device while the first user device reproduces audio captured by the third user device if the first user is predicted or determined to be able to hear the second user directly.

In a third aspect of the invention, a method of facilitating audio conferencing may comprise predicting or determining whether a first user of a first user device is able to hear a second user of a second user device directly, and enabling the first user device to reproduce audio captured by the second user device while the first user device reproduces audio captured by a third user device if the first user is predicted or determined not to be able to hear the second user directly or preventing that the first user device reproduces audio captured by the second user device while the first user device reproduces audio captured by the third user device if the first user is predicted or determined to be able to hear the second user directly. The method may be performed by software running on a programmable device.

This software may be provided as a computer program product.

In a fourth aspect of the invention, an audio conferencing facilitating device comprises at least one processor that may be configured to predict or determine at a first moment whether a first user of a first user device is able to hear a second user of a second user device directly, predict or determine at a second moment whether the first user is able to hear the second user directly, cause the first user device to stop reproducing audio captured by the second user device if the first user was predicted or determined not to be able to hear the second user directly at the first moment and is predicted or determined to be able to hear the second user directly at the second moment, and cause the first user device to start reproducing audio captured by the second user device if the first user was predicted or determined to be able to hear the second user directly at the first moment and is predicted or determined not to be able to hear the second user directly at the second moment.

In a fifth aspect of the invention, an audio conferencing facilitating device comprises at least one processor that may be configured to receive audio captured by a user device, determine whether the audio captured by the user device comprises first audio information originating from a same source as second audio information comprised in the audio captured by a further user device, and remove the second audio information from the audio captured by the further user device or remove the first audio information from the audio captured by the user device if the first audio information and the second audio information are determined to originate from the same source.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a software code portion, the software code portion, when executed or processed by a computer, being configured to perform executable operations for facilitating audio conferencing.

The executable operations may include predicting or determining whether a first user of a first user device is able to hear a second user of a second user device directly, and enabling the first user device to reproduce audio captured by the second user device while the first user device reproduces audio captured by a third user device if the first user is predicted or determined not to be able to hear the second user directly or preventing that the first user device reproduces audio captured by the second user device while the first user device reproduces audio captured by the third user device if the first user is predicted or determined to be able to hear the second user directly.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of facilitating audio conferencing;

FIG. 2 shows an example to illustrate the method of FIG. 1;

FIG. 3 is a flow diagram of a second embodiment of the method of facilitating audio conferencing;

FIG. 4 shows three types of audio conferencing systems;

FIG. 5 is a block diagram of a first embodiment of the audio conferencing system;

FIG. 6 is a block diagram of a second embodiment of the audio conferencing system;

FIG. 7 is a block diagram of a third embodiment of the audio conferencing system;

FIG. 8 is a block diagram of a fourth embodiment of the audio conferencing system;

FIG. 9 is a block diagram of a fifth embodiment of the audio conferencing system;

FIG. 10 is a flow diagram of a method which solves the problem of dual capture;

FIG. 11 is a flow diagram of a third embodiment of the method of facilitating audio conferencing;

FIG. 12 is a flow diagram of a fourth embodiment of the method of facilitating audio conferencing; and

FIG. 13 is a block diagram of an exemplary data processing system for performing the method of the invention.

Corresponding elements in the drawings are denoted by the same reference numeral.

### DETAILED DESCRIPTION OF THE DRAWINGS

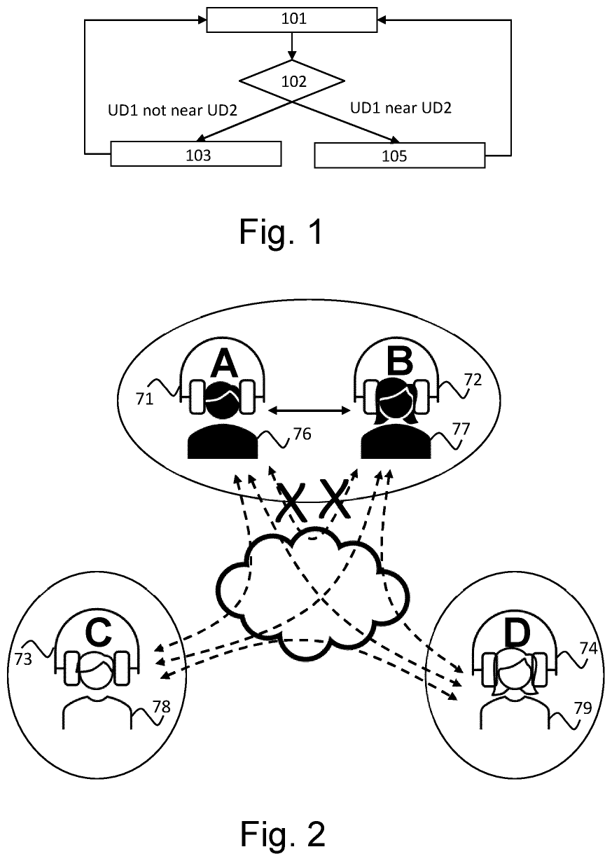

A first embodiment of the method of facilitating audio conferencing is shown in FIG. 1. A step 101 comprises predicting or determining whether a first user of a first user device (UD1) is able to hear a second user of a second user device (UD2) directly. This may be predicted based on proximity and/or location data or determined based on user input from the first user, for example. A step 102 comprises checking whether it was determined in step 101 that the first user is able to hear the second user directly. If so, a step 105 is performed. If not, a step 103 is performed.

Step 103 comprises enabling the first user device to reproduce audio captured by the second user device while the first user device reproduces audio captured by a third user device. Step 105 comprises preventing that the first user device reproduces audio captured by the second user device while the first user device reproduces audio captured by the third user device if the first user is predicted or determined to be able to hear the second user directly.

Predicting whether the first user is able to hear the second user directly may involve applying an audio volume threshold, which may be dependent on whether users wear headphones/earphones and if so whether they allow environmental audio through, whether hear-through functionality is enabled or environmental noise suppression functionality activated, for example. A threshold may additionally or alternatively depend on the environment, e.g. a lower threshold for an environment such as a conference room, and a higher threshold for an environment where more background noise is present, other people talking, music playing, for example.

Step 101 is repeated after step 103 or step 105 is performed, and the method then proceeds as shown in FIG. 1. Thus, the method comprises predicting or determining at least at a first moment and at a second moment whether the first user is able to hear the second user. The method comprises causing the first user device to stop reproducing audio captured by the second user device in step 105 if the first user was predicted or determined not to be able to hear the second user directly at the first moment in a first iteration of step 101 and is predicted or determined to be able to hear the second user directly at the second moment in a second iteration of step 101.

The method further comprises causing the first user device to start reproducing audio captured by the second user device in step 103 if the first user was predicted or determined to be able to hear the second user directly at the first moment in the first iteration of step 101 and is predicted or determined not to be able to hear the second user directly at the second moment in the second iteration of step 101.

The method of FIG. 1 works best if headphones/ear buds are used that allow environmental audio through. Audio is then added only for people not in a user's proximity (e.g. for people in the same group of users) while keeping the rest (i.e. environmental sounds) the same. These may be either so-called ‘open’ earbuds or headphones that physically let local sound pass through (also often found on AR headsets) or active noise cancelling earbuds or headphones that have an ‘environment mode’ that actively plays back external sounds picked up by the microphones.

FIG. 2 shows an example to illustrate the method of FIG. 1. The shown audio conferencing system comprises user devices 71-74 and optionally a central audio device. Users 76 to 79 wear user devices 71-74, respectively. User devices 71-74 may be standalone devices, such as special AR audio devices, or devices tethered to another device, e.g. to a smartphone. User devices 71-74, e.g. headphones, may have microphones included or may use microphones, or other means to capture a user's voice, which are integrated in another device, e.g. in a separate device or in another user device used by the same user, e.g. a smartphone. FIG. 2 shows with dashed arrows which user device reproduces audio captured by which other user device.

Steps 101-105 of FIG. 1 are performed at least once per pair of user devices. In a first variant, step 101 is performed once per pair of user devices and if the first user is predicted to hear the second user directly, the second user is automatically predicted to hear the first user directly. In a second variant, step 101 is performed twice per pair of user devices. In the latter case, it is not assumed that if the first user can hear the second user directly, the second user can also hear the first user directly. For example, the type of headphones and/or the user's hearing quality, e.g. in case of hearing impairment, may be taken into account. One or more of the user devices 71-74 may even be hearing aids. Step 103 or step 105 is performed for each pair of user devices per user device. For example, user device 71 decides whether to mute audio captured by user device 71 on user device 72 and user device 72 decides whether to mute audio captured by user device 72 on user device 71. Muting audio captured by a second user device on a first user device means preventing the first user device from reproducing audio captured by the second user device.

In the example of FIG. 2, users 76 and 77 can hear each other directly and step 105 is therefore performed for the user device 71 with respect to the audio captured by the user device 72 and for the user device 72 with respect to the audio captured by the user device 71. Thus, it is prevented that the user device 71 reproduces audio captured by the user device 72 and it is prevented that the user device 72 reproduces audio captured by the user device 71.

In the example of FIG. 2 users 78 and 79 cannot hear any other user directly and users 76 and 77 cannot hear user 78 or user 79 directly. Step 103 is therefore performed for the user devices 73 and 74 with respect to the audio captured by the other user devices and for the user devices 71 and 72 with respect to the audio captured by the user devices 73 and 74. Thus, the user devices 73 and 74 are enabled to reproduce the audio captured by the other user devices and the user devices 71 and 72 are enabled to reproduce the audio captured by the user devices 73 and 74.

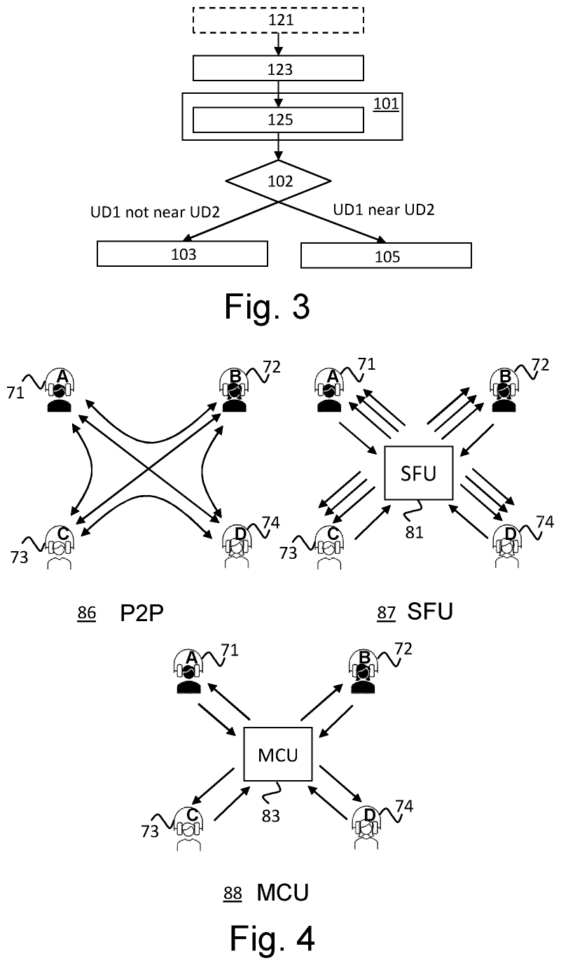

A second embodiment of the method of facilitating audio conferencing is shown in FIG. 3. The second embodiment of FIG. 3 is an extension of the first embodiment of FIG. 1. In the embodiment of FIG. 3, steps 121 and 123 are performed before step 101 of FIG. 1 and step 101 of FIG. 1 has been implemented by a step 125.

Step 121 comprises identifying which devices are part of a certain group. For example, in a museum, there are normally multiple groups of persons that visit the museum at the same time. Persons within a group would like to talk to each other but not to persons in other groups. Similarly, there may be multiple groups of persons on different conference calls in an office. The groups are typically managed by a central server. Users may be able to indicate which group they want to join.

Step 123 comprises obtaining proximity and/or location data of the devices identified in step 121. The proximity and/or location data are indicative of a proximity of a first user device to at least a second user device and/or indicative of at least a location of the first user device and a location of the second user device. If the group comprises more than two devices, then the proximity and/or location data are also indicative of proximities and/or locations with respect to these other devices. Steps 121 and 123 may be performed per group of users devices, e.g. if step 123 comprises determining location data, but may alternatively be performed per pair of user devices, e.g. if just Bluetooth scanning is used for determining proximity of neighbors. Steps 121 and 123 may be performed once, but are typically repeated over time (to handle groups that change over time such as users joining or leaving the group, or users moving around or changing location over time).

Proximity may be determined in different ways. Proximity may be determined using a wireless probe signal. For example, the second user device may transmit an RF (e.g. Bluetooth or Wi-Fi), (ultra) sound, or infrared signal, and the first user device may in the same time interval receive that signal, i.e. listen for that signal and determine whether it is received and received with sufficient strength to be in proximity. Alternatively, the wireless probe signal may, for example, trigger a response, similar to a ‘ping’ on the Internet, where one user device requests a response from another user device by sending a wireless signal and the other user device responds to this signal. In this way, both user devices may be able to determine proximity from a single request-response exchange or both user devices may send both requests and responses.

Step 125 comprises predicting based on the proximity and/or location data obtained in step 123 whether the first user of the first user device is able to hear the second user of the second user device directly. Next, steps 102, 103, and 105 are performed as described in relation to FIG. 1. Steps 121 and 123 and steps 101-105 may be performed for a plurality of groups, e.g. if the method is performed by a central audio device.

In the embodiment of FIG. 3, when people are in physical proximity, they do not hear each other through the audio conferencing system, but they just talk to each other directly. When further away, people remain able to talk to each other and hear each other through the audio conferencing system.

FIG. 4 shows three types of audio conferencing systems: a peer-to-peer (P2P) audio conferencing system 86, an audio conferencing system 87 which uses a Stream Forwarding Unit (SFU) 81, and an audio conferencing system 88 which uses Multipoint Control Unit (MCU) 83. In the P2P audio conferencing system 86, the audio streams are transmitted directly from user devices to other user devices and not to a central audio device.

The MCU 83 mixes audio captured by multiple devices in a single stream customized for a single user device and transmits this single stream to this user device. The MCU 83 does this for each user device. Each user device therefore only transmits one audio stream and receives one audio stream.

The SFU 81 is a central server that has individual signaling connections with each of the user devices in a session. Contrary to an MCU, an SFU will not decode and mix media streams; it will simply forward media packets arriving on one incoming connection to all outgoing connections that have requested the specific media stream.

As such, an SFU is the signaling endpoint for each of the user devices. In SIP (Session Initiation Protocol) terms this would be called a B2BUA, i.e. a Back-to-Back User Agent. This means that the server functions as a regular user agent towards each user device, and internally connects the user agents towards various user devices. If other protocols are used, the same concept applies.

To allow for this to work, like in a P2P system but unlike in an MCU-based system, each user device needs to support the media codecs used by the other user devices to encode/format their streams. For example, generally available codecs may be used. For a specific application, a specific codec may be used if all user devices of the users in a group are the same or run the same application.

On the stream forwarding level, the SFU 41 has a role to play as well. Even though it does not decode and mix media streams as the MCU 43 does, it will have to ensure that each user will receive a proper media stream. Therefore, SFU 41 may be configured to rewrite RTP headers such as SSRC numbers (used for identification of streams) and sequence numbers. A more thorough description of this can be found in e.g. IETF RFC 7667 on RTP topologies.

Typically, when SDP (Session Description Protocol) offer/answer is used to perform the signaling for the media streams to be exchanged (as e.g. in WebRTC), a user device will describe (i.e. offer) the streams it has available to the SFU 81, and the SFU 81 will describe (i.e. offer) the streams is has available to the user device. While each user device has typically only one or two streams to offer, e.g. an audio and perhaps a video stream, the SFU 81 will have many streams to offer: one or perhaps two for each incoming stream from each other user device. The following additional concepts can be used specifically for video if an SFU is used:
Since not all receiving user devices have the same bandwidth available, some user devices may want higher quality and thus higher bandwidth streams than others. This can be achieved by either simulcast (i.e. each user device provides various quality streams to the SFU) or by using scalable video codecs (i.e. each user device provides content in a layered fashion, where a base layer offers a base quality and addition of other layers will improve quality and will require more bandwidth).
Some media transmission mechanisms include retransmissions for lost packets. When a packet is lost only to a certain receiving user device, it should not be retransmitted to all user devices. This requires either caching and retransmission by the SFU, or careful state management to only forward retransmitted packets to the correct user devices.

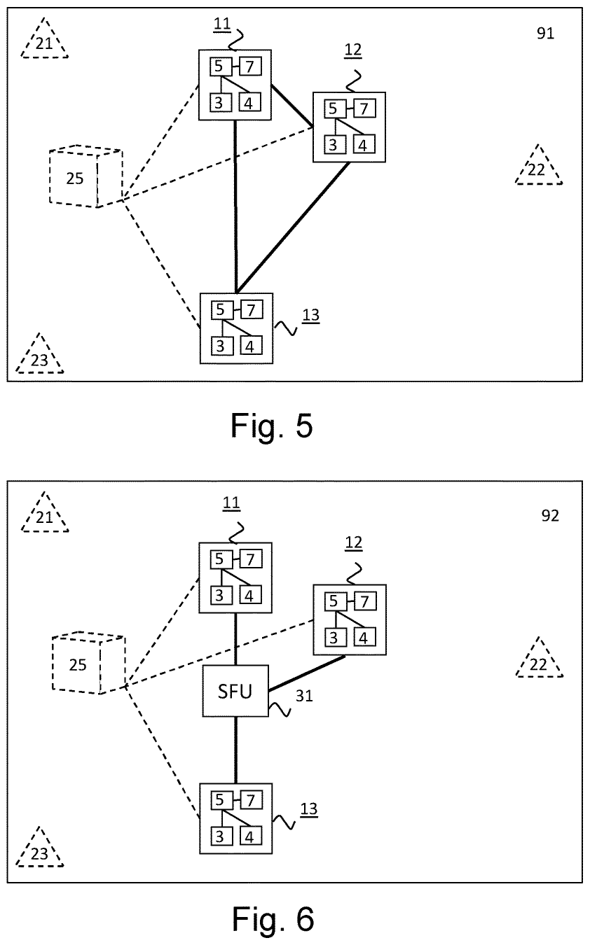

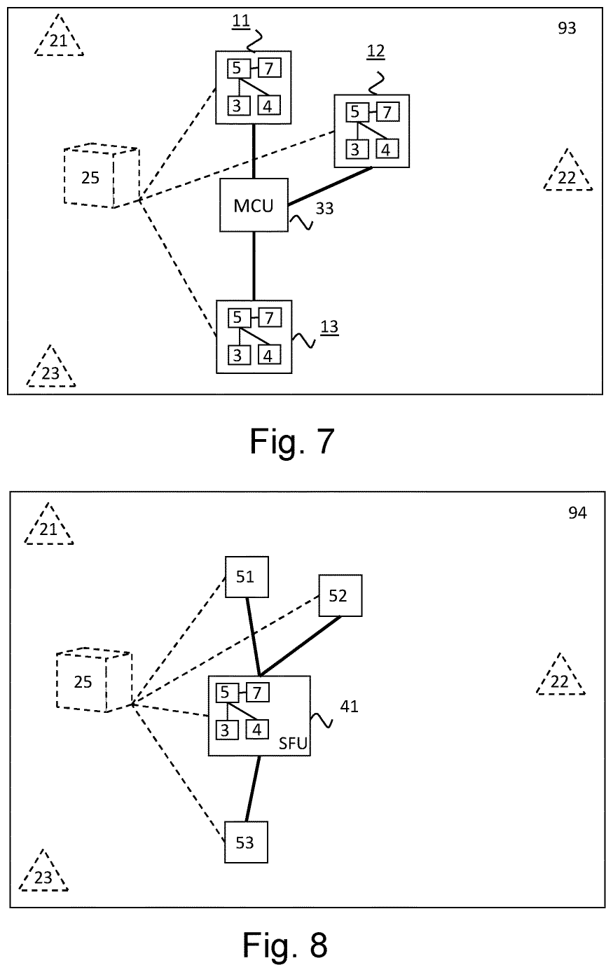

FIGS. 5-7 are a block diagrams of respectively a first embodiment, a second embodiment, and a third embodiment of an audio conferencing system. In the embodiment of FIG. 5, the audio conferencing system 91 is a P2P system which comprises three user devices 11-13. In the embodiment of FIG. 6, the audio conferencing system 92 comprises three user devices 11-13 and an SFU 31. In the embodiment of FIG. 7, the audio conferencing system 93 comprises three user devices 11-13 and an MCU 33. These three types of audio conferencing systems have been described in relation to FIG. 4.

Each user device comprises a receiver 3, a transmitter 4, a processor 5, and a memory 7. The processors 5 are configured to predict or determine whether a first user of a first user device is able to hear a second user of a second user device directly, and enable the first user device to reproduce audio captured by the second user device while the first user device reproduces audio captured by a third user device if the first user is predicted or determined not to be able to hear the second user directly or prevent that the first user device reproduces audio captured by the second user device while the first user device reproduces audio captured by the third user device if the first user is predicted or determined to be able to hear the second user directly.

The processors 5 are configured to predict or determine whether the first user of the first user device is able to hear a third user of the third user device directly, and if the first user is predicted or determined not to be able to hear the third user directly, enable the first user device to reproduce audio captured by the second user device and audio captured by the third user device if the first user is predicted or determined not to be able to hear the second user directly or prevent that the first user device reproduces audio captured by the second user device while the first user device reproduces audio captured by the third user device if the first user is predicted or determined to be able to hear the second user directly. In the embodiments of FIGS. 5-9, the processors 5 are configured to obtain proximity and/or location data and predict based on the proximity and/or location data whether the first user of the first user device is able to hear the second user of the second user device directly. The proximity and/or location data is indicative of a proximity of the first user device to at least the second user device and/or indicative of at least a location of the first user device and a location of the second user device. Well known techniques may be used for determining proximity and/or locations.

For example, each user device may obtain/determine proximity data based (only) on own signal strength measurements. In this case, each user device determines which other user devices are nearby based on RF signal strength of received RF signals, e.g. Bluetooth or Wi-Fi signals. Location data may be used instead of or in addition to proximity data. For example, each user device may determine its own location using beacons 21-23 and share its location wither with the other user devices or with a server 25. The server 25 may then share the location data it has received with the user devices. Server 25 may have an API or comparable interface through which the user devices can share and obtain these location data. Location data may be relative location data, i.e. being location data that is indicating where a user in inside a specific location, or it may be absolute location data, i.e. describing an exact physical location on earth.

Proximity may be determined based on the locations of the user devices and a certain threshold, e.g. users being closer than 2 meters apart. However, there are obvious situations in which users that are that close can still not hear each other normally: when there is a wall or window in between them. For example, in a museum, two users may be in completely different rooms, but could be physically really close to each other.

A benefit of using location data is that it makes it possible to better determine whether two users are able to hear each other directly. By using location data and a building map that indicates walls, windows, and ceilings, a user device may be able to determine whether other user devices are in the same room. If the user devices obtain the location data from the server 25, they may be able to obtain the map from the same server 25. If the user devices obtain location data from the other user devices, the user devices may be able to obtain the map from the server 25. The server 25 may also act as a beacon.

The user devices 11-13 may determine which of the received proximity and/or location data is relevant by using group information. As part of the group management, devices may have exchanged hardware addresses of the interfaces used, or the device may broadcast its identity maybe together with a group identity, or the devices may be paired or directly connected, etc.

In a first implementation of the user devices 11-13, the processor 5, e.g. of user device 11, is configured to predict or determine whether a user of the user device is able to hear a first other user of a first other user device, e.g. user device 12, directly, determine whether the user of the user device is able to hear a second other user of a second other user device, e.g. user device 13, directly, and if the user is predicted or determined not to be able to hear the second other user directly, enable the user device to reproduce audio captured by the first other user device and audio captured by the second other user device if the user is predicted or determined not to be able to hear the first other user directly or prevent that the user device reproduces audio captured by the first other user device while the user device reproduces audio captured by the second other user device if the user is predicted or determined to be able to hear the first other user directly. Thus, in this first implementation, it is the receiving user device which decides whether to mute the audio captured by transmitting user devices on the receiving user device.

In the example of FIG. 2, if the user devices 71-74 would be implemented in this manner, the user device 71 would prevent the audio captured by user device 72 from being reproduced on the user device 71 and the user device 72 would prevent the audio captured by user device 71 from being reproduced on the user device 72. The user device 71 would enable the audio captured by user devices 73 and 74 to be reproduced on the user device 71.

In the embodiments of FIGS. 5-7, in the first implementation of the user devices 11-13, the processor 5 of the first user device may be configured to prevent that the first user device reproduces audio captured by the second user device by adjusting its processing of received audio packets such that the audio captured by the second user device is not reproduced or by instructing the second user device to prevent that the first user device reproduces audio captured by the second user device. The second user device may prevent this in a similar manner as will be described in relation to the second implementation, in which the second user device decides whether to mute the audio captured by the second user device on the first user device.

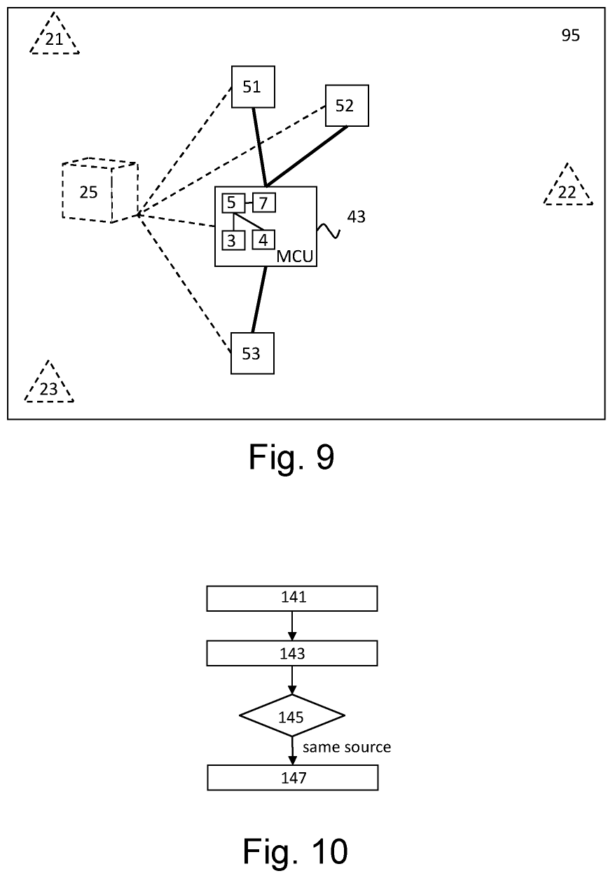

As an example of instructing the second user device, the processor 5 of the first user device may, in the embodiment of FIG. 5, instruct the second user device not to transmit an audio stream to the first user device. A typical protocol for managing and controlling audio streams is WebRTC. Muting may be e.g. realized in WebRTC by (the first user device) updating the media direction to ‘sendonly’, which effectively leads to an SDP exchange that stops the WebRTC client (of the second user device) from sending audio. In the embodiments of FIGS. 5-7, in the first implementation of the user devices 11-13, the processor 5 of the first user device may alternatively be configured to prevent that the first user device reproduces audio captured by the second user device by instructing the central audio system, SFU 31 of FIG. 6 and MCU 33 of FIG. 7, to prevent that the first user device reproduces audio captured by the second user device. The SFU 31 of FIG. 6 may prevent this in a similar manner as the SFU 41 of FIG. 8. The MCU 33 of FIG. 7 may prevent this in a similar manner as the MCU 43 of FIG. 9.

In a second implementation of the user-devices 11-13, the processor 5, e.g. of user device 12, is configured to predict or determine whether a first other user of a first other user device, e.g. user device 11, is able to hear a user of the user device directly, and enable the first other user device to reproduce audio captured by the user device while the first other user device reproduces audio captured by a second other user device, e.g. user device 13, if the first other user is predicted or determined not to be able to hear the user directly or prevent that the first other user device reproduces audio captured by the user device while the first other user device reproduces audio captured by the second other user device if the first other user is predicted or determined to be able to hear the user directly. Thus, in this second implementation, it is the transmitting user device which decides whether to mute the audio captured by the transmitting user device on a receiving user device.

In the example of FIG. 2, if the user devices 71-74 would be implemented in this manner, the user device 71 would prevent the audio captured by user device 71 from being reproduced on the user device 72 and the user device 72 would prevent the audio captured by user device 72 from being reproduced on the user device 71. The user device 73 would enable the audio captured by user device 73 to be reproduced on the user device 71. The user device 74 would enable the audio captured by user device 74 to be reproduced on the user device 71.

In the embodiments of FIGS. 5-7, in the second implementation of the user devices 11-13, the processor 5 of the second user device may be configured to prevent that the first user device reproduces audio captured by the second user device by sending an instruction over a network to the first user device. The instruction instructs the first user device not to reproduce audio captured by the second user device. The instruction may indicate whether or not the user device receiving the instruction should reproduce the audio captured by the originating user device or may indicate a list of user devices which should or should not reproduce the audio captured by the originating user device, for example. Instead of indicating whether a user device should reproduce the audio or not, a volume level for reproducing the audio may be specified in the instruction.

The instruction may be included as metadata in the audio stream in the embodiment of FIG. 5 or may be signaled in the embodiments of FIGS. 5 and 6. Muting may be e.g. realized in WebRTC by (the second user device) updating the media direction to ‘recvonly’, which effectively leads to an SDP exchange that stops the WebRTC client (of the second user device) from sending audio. This effectively signals to the remote side that the microphone is muted. Since the user device only receives one audio stream in the embodiment of FIG. 7, signaling would not be useful in this embodiment.

In the embodiment of FIG. 5, in the second implementation of the user devices 11-13, the processor 5 of the second user device may alternatively be configured to prevent that the first user device reproduces audio captured by the second user device by not transmitting audio captured by the second user device to the first user device, e.g. by not transmitting any audio stream to from the second user device to the first user device (also referred to as “send_none”) or by transmitting an audio stream with silence from the second user device to the first user device (also referred to as “send_silent”).

This is not possible in the embodiments of FIGS. 6 and 7, because each user device only transmits one audio stream with audio captured by the user device and a user device not transmitting the audio that it captures would mean that none of the user devices would be able to reproduce audio captured by this user device. Send_none may be implemented by just stopping the sending of audio packets. Send_silent may be an action by the audio component itself. Instead of encoding the audio received from the microphone, it may pass audio packets containing no audio.

In an alternative implementation of the user devices 11-13, a first user device may prevent audio captured by a second user device from being reproduced on the first user device and also prevent audio by captured by the first user device from being reproduced on the second user device. In the example of FIG. 2, if the user devices 71-74 would be implemented in this manner, either the user device 71 or the user device 72 would prevent the audio captured by user device 72 from being reproduced on the user device 72 and the audio captured by user device 71 from being reproduced on the user device 71.

In the embodiment shown in FIGS. 5 to 7, the user devices 11-13 comprise one processor 5. In an alternative embodiment, one or more of the user devices 11-13 comprise multiple processors. The processor 5 may be a general-purpose processor, e.g., an ARM or Qualcomm processor, or an application-specific processor. The processor 5 may run a Unix-based operating system (e.g. Google Android) or Apple iOS as operating system, for example. The processor may comprise multiple cores, for example. The memory 7 may comprise solid state memory, e.g., one or more Solid State Disks (SSDs) made out of Flash memory, or one or more hard disks, for example.

The receiver 3 and the transmitter 4 of the user devices 11-13 may use one or more wireless communication technologies such as Wi-Fi, LTE, and/or 5G New Radio to communicate with other devices on the Internet, for example. The receiver 3 and the transmitter 4 may be combined in a transceiver. The user devices 11-13 may comprise other components typical for user devices, e.g., a battery and/or a power connector.

FIGS. 8-9 are a block diagrams of respectively a fourth embodiment and a fifth embodiment of an audio conferencing system. In the embodiment of FIG. 8, the audio conferencing system 94 comprises three user devices 51-53 and an SFU 41. In the embodiment of FIG. 9, the audio conferencing system 95 comprises three user devices 51-53 and an MCU 43. These two types of audio conferencing systems have been described in relation to FIG. 4.

The SFU 41 of FIG. 8 and the MCU 43 of FIG. 9 each comprises a receiver 3, a transmitter 4, a processor 5, and a memory 7. The processor 5 of the SFU 41 or MCU 43 is configured to predict or determine whether a first user of a first user device is able to hear a second user of a second user device directly, and enable the first user device to reproduce audio captured by the second user device while the first user device reproduces audio captured by a third user device if the first user is predicted or determined not to be able to hear the second user directly or prevent that the first user device reproduces audio captured by the second user device while the first user device reproduces audio captured by the third user device if the first user is predicted or determined to be able to hear the second user directly.

The processor 5 of the SFU 41 or MCU 43 is further configured to predict or determine whether the first user of the first user device is able to hear a third user of the third user device directly, and if the first user is predicted or determined not to be able to hear the third user directly, enable the first user device to reproduce audio captured by the second user device and audio captured by the third user device if the first user is predicted or determined not to be able to hear the second user directly or prevent that the first user device reproduces audio captured by the second user device while the first user device reproduces audio captured by the third user device if the first user is predicted or determined to be able to hear the second user directly.

In the embodiments of FIGS. 8 and 9, the SFU 41 and the MCU 43 obtain proximity and/or location data from the user devices 51-53 or obtain location data from the server 25. Instead of obtaining location data from the server 25, the SFU 41 and/or the MCU 43 may store the location data and/or the map themselves. In this case, a separate server 25 may not be necessary. Each of the user devices 51-53 may determine its location using beacons 21-23 and share this with the SFU 41 and/or the MCU 43.

In the embodiment of FIGS. 8 and 9, the processor 5 of the SFU 41 or MCU 43 may be configured to prevent that the first user device reproduces audio captured by the second user device by not transmitting audio captured by the second user device to the first user device. For example, in the embodiment of FIG. 9, the processor 5 of the MCU 43 may be configured to prevent that the first user device reproduces audio captured by the second user device by omitting the audio captured by the second user device from the single stream transmitted to the first user device (send_silent).

In the embodiment of FIG. 8, the processor 5 of the SFU 41 may be configured not to transmit any data stream on behalf of the first user device to the second user device (send_none). Thus, the SFU 41 selectively forwards certain audio streams and not others. SFU 41 can simply stop forwarding packets to certain users without any signaling.

In the embodiment of FIG. 8, the processor 5 of the SFU 41 may alternatively be configured to prevent that the first user device reproduces audio captured by the second user device by sending an instruction over a network to the first user device. The instruction instructs the first user device not to reproduce audio captured by the second user device. The instruction may indicate whether or not the user device receiving the instruction should reproduce audio included in a certain audio stream or may indicate a list of user devices which should or should not reproduce the audio included in a certain audio stream, for example. The instruction may be signaled, for example. For example, the SFU 41 may select the streams that a receiving user device needs and use signaling, e.g. SDP signaling, to indicate which streams the receiving user device should reproduce.

Thus, when an MCU is used, each user device sends their stream once to the MCU. The MCU mixes an output for each individual user device, containing the audio of the other users, and sends this to the user devices. Because the audio is modified by the MCU, it may use send_silent, but it cannot use send_none, as audio still needs to be send for the other users. And, as the individual streams are no longer identifiable, using signaling or metadata will not work.

When an SFU is used, each user device sends their stream once to the SFU. The SFU copies the audio stream and sends it to each other user device, without modifying the audio. In this case, the signaling method can work, as can send_none by just not copying the audio packets for some receiving user. But, send_silent is not available, as the SFU does not manipulate audio streams themselves. And, the use of metadata also does not work, as all users receive (copies of) the same audio streams.

In the embodiments shown in FIGS. 8 and 9, the SFU 41 and MCU 43 each comprise one processor 5. In an alternative embodiment, the SFU 41 and/or the MCU 43 comprises multiple processors. The processor 5 may be a general-purpose processor, e.g., an Intel or AMD processor, or an application-specific processor. The processor 5 may run a Unix-based operating system or a Windows operating system, for example. The processor 5 may comprise multiple cores, for example. The memory 7 may comprise solid state memory, e.g., one or more Solid State Disks (SSDs) made out of Flash memory, or one or more hard disks, for example. Alternatively, the SFU 41 and MCU 43 may be run in a cloud network or edge network, typically with scalable processing and storage capability. In an even further embodiment, one of the user devices acts as the server 25, the SFU 41 and/or the MCU 43. The receiver 3 and the transmitter 4 of may use one or more wireless communication technologies such as Wi-Fi, LTE, and/or 5G New Radio to communicate with other devices on the Internet, for example. The receiver 3 and the transmitter 4 may be combined in a transceiver. The SFU 41 and MCU 43 may comprise other components typical for a central audio device, e.g., a power connector.

In the above description of FIGS. 5 to 9, it was described how a receiving user device can decide whether to mute audio captured by a transmitting user device on the receiving device, either by adjusting its processing of received audio packets or by instructing the transmitting user device or a central audio device. In the above description of FIGS. 5 to 9, it was further described how the transmitting user device or a central audio device can decide whether to mute audio captured by the transmitting user device on the receiving device and four implementations of this were described:
1. Send_none: Not sending any audio for a certain user;
2. Send_silent: Sending ‘silent’ audio for a certain user;
3. Signal: Indicating in signaling that audio for a certain user should not be reproduced;
4. Metadata: Indicating in metadata of the audio stream that audio should not be reproduced.

If a central audio device is used, it is the central audio device that uses option 1 or option 2 and not the transmitting user device. The first option is the most efficient for the network, but this may cause an issue if the receiving user device stops functioning when it no longer receives audio packets. The second option prevents that issue, but requires modification of the audio and thus more processing. Use of signaling or metadata prevents this audio processing, and allows for more immediate unmuting when users leave each other's proximity (as the audio is still being delivered). Also, combinations of these options may be applied, such as e.g. signaling and also no longer sending audio.

Table 1 below gives an overview of the various options that have been described in relation to the embodiments of FIGS. 5 to 9 for the embodiments or implementations in which the transmitting user device or the central audio device decides whether to mute audio captured by the transmitting user device on the receiving device. Other options may also be possible, e.g. an SFU may be adjusted to be able to modify outgoing metadata in RTP headers and thus support the metadata option.

TABLE 1

| | Send_none | Send_silent | Signaling | Metadata |
|---|---|---|---|---|
| P2P | X | X | X | X |
| SFU | X | | X | |
| MCU | | X | | |

Optionally, the user devices 11-13 and/or 51-53 of FIGS. 5-9 may use earbuds or headphones that are capable of reproducing spatial audio. The audio of the remote user speaking may then sound as coming from the physical direction that person actually is. Spatial audio may work using object-based spatial audio in the P2P and SFU embodiments, or using omnidirectional audio in the MCU embodiments.

Optionally, the above-described audio conferencing may be combined with video conferencing. When users are local, they do not see nor hear each other. When users are farther apart, they see a video projection or some other representation of the other user (possibly in the direction that user physically is) and hear each other as well through the audio conferencing system.

In the case of a (shared) audio tour, if the live tour guide is not part of the group, the user devices 11-13 and/or 51-53 of FIGS. 5-9 may not only be used for talking to the group, but also for hearing the live tour guide.

The method described in FIG. 1 is able to facilitate audio conferencing without annoying echo and with good lip-sync even when multiple users are near each other but not near a conferencing speaker system. Additional measures may be used to address the dual-capture problem: when the same audio is recorded by two microphones because two user devices are in close proximity, this may lead to echo issues (i.e. same audio played multiple times with small but noticeable playback delays). Such echo issues may arise if the capture is de-synchronized (e.g. due to hardware differences between capture devices), if the transmission of audio streams captured from different user devices suffer from different delays (e.g. due to network bandwidth differences or different network routes), or both.

This dual-capture problem does not always occur. In practice, with all users having modern smartphones, and when using a single communication service with the same settings (e.g. used codecs, buffer settings, etc.) for each user device, delay differences will most likely be negligible and echo issues will likely not occur. Furthermore, modern headphones and earbuds are really good at picking up the user's voice and filtering out environmental noises and may thereby help prevent echo issues by not picking up other users' voices.

If the dual-capture problem does occur, it can be very annoying. There are several ways of addressing this problem. First, by synchronizing the capture through multiple microphones, playback of captured audio can also be synchronized. Such capture synchronization is well known. The most used method for this is to synchronize the clocks on the capture devices, e.g. using NTP, GPS, or cellular clock sync, and then to timestamp the captured audio packets in the media stream with these synchronized clocks. This timestamping can be done by inserting the timestamp in the headers of the audio packets, or by signaling the relationship between audio packets' timestamps and the clock timestamp (e.g. in case of RTP timestamps, which are randomly offset normally). This should be done periodically to account for clock drift. Next, inter-media synchronization should be applied.

The alternative to playback synchronization is to use echo cancellation. Echo cancellation works on the principle of finding an audio pattern from one piece of audio in some potentially modified form in another piece of audio, usually within a certain delay from the first pattern. Usually, this works on a single device: the incoming audio is played back through a speaker and then captured through a microphone on the same device (acoustic echo). The played out audio as picked up by the microphone is then filtered (i.e. cancelled) out of the outgoing audio.

FIG. 10 is a flow diagram of a method which addresses the problem of dual capture with the help of echo cancellation. The method of FIG. 10 comprise steps 141, 143, 145, and 147. A step 141 comprises receiving audio captured by a third user device. A step 143 comprises determining whether the audio captured by the third user device comprises first audio information originating from a same source as second audio information comprised in the audio captured by a second user device.

A step 145 comprises checking whether it was determined in step 143 that the audio captured by the third user device comprises first audio information originating from a same source as the second audio information. If so, a step 147 is performed. Step 147 comprises removing the second audio information from the audio captured by the second user device or removing the first audio information from the audio captured by the third user device if the first audio information and the second audio information are determined to originate from the same source.

Removing audio information may comprise audio processing such as cancelling the audio information in the captured audio or subtracting the audio information from the captured audio. This cancellation/subtraction typically uses comparable techniques as (regular) echo cancellation. The audio captured by the second and third user devices, minus any removed audio information, is reproduced on the first user device (not shown in FIG. 10).

The echo cancellation of FIG. 10 works differently than the standard echo cancelling scenario described above, as the audio that is picked up twice is picked up by two different devices. In the example of proximity between the first user and the second user, the speech of the first user may get picked up by both microphones, as will the speech of the second user. Although it is harder to figure out which audio signal to cancel in which stream compared to classic echo cancellation, audio volumes may be used to distinguish between a device's own user (who will, by assumption, be closest to his or her own microphone and thus have a higher volume) and the other user.

Furthermore, technologies such a disclosed in EP3175456 A1 may be used to realize the echo cancellation. In the case of EP3175456 A1, instead of a play-out device, a user of a second communication device creates the sound signal recorded by the first communication device. Since the second communication device also records the sound signal created by its user, the second communication device can provide noise suppression data.

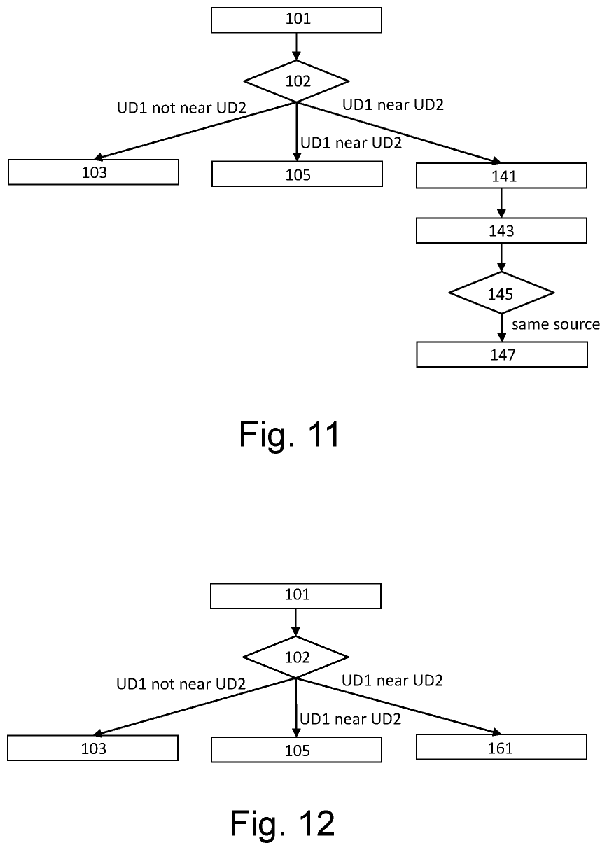

A third embodiment of the method of facilitating audio conferencing, which addresses the problem of dual capture, is shown in FIG. 11. The third embodiment of FIG. 11 combines the first embodiment of FIG. 1 and the method of FIG. 10. In the embodiment of FIG. 11, steps 141, 143, and 145 of FIG. 10 are additionally performed after step 102 if it was determined in step 101 that the first user is able to hear the second user directly. Step 147 is performed after step 145 if it was determined in step 143 that the audio captured by the third user device comprises first audio information originating from a same source as the second audio information. Steps 141-147 have been described in relation to FIG. 10.

A fourth embodiment of the method of facilitating audio conferencing, which also addresses the problem of dual capture, is shown in FIG. 12. The fourth embodiment of FIG. 12 is an extension of the first embodiment of FIG. 1. In the embodiment of FIG. 12, a step 161 is additionally performed after step 102 if it was determined in step 101 that the first user is able to hear the second user directly. Step 161 comprises deactivating either capturing and/or transmission of audio by the first user device or capturing and/or transmission of audio by the second user device.

In the embodiment of FIG. 12, the audio captured by the first user device and the audio captured by the second user device are determined or expected to comprise audio information from the same source if the first user is able to hear the second user directly. In an alternative embodiment, it is determined in a different way whether the audio captured by the first user device and the audio captured by the second user device are determined or expected to comprise audio information from the same source and step 161 is performed in dependence on the outcome of this determination.

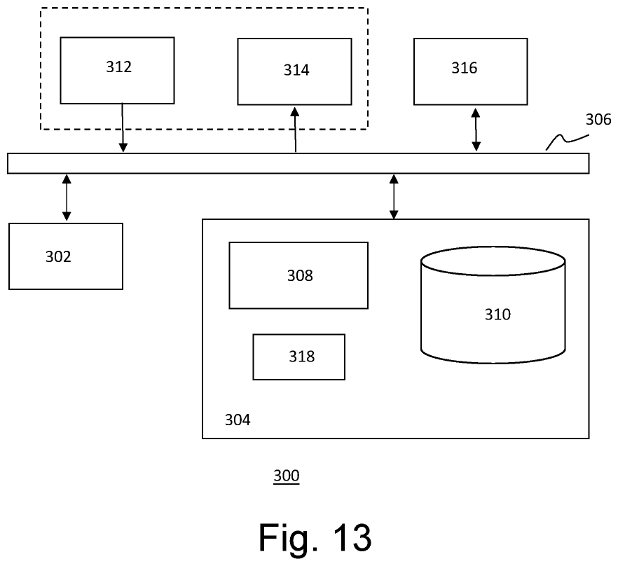

FIG. 13 depicts a block diagram illustrating an exemplary data processing system that may perform the method as described with reference to FIGS. 1, 3, and 10-12. The data processing system is also exemplary for the audio conferencing facilitating device and/or any of the user devices disclosed herein, e.g. user devices 51-53 of FIGS. 8-9.

As shown in FIG. 13, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 13 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display. A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300. The network adapter 316 may support one or more wired networks and/or one or more wireless networks (e.g. Wi-Fi and/or Bluetooth).

As pictured in FIG. 13, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 13) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. An audio conferencing facilitating device, wherein
the audio conferencing facilitating device comprises at least one processor configured to:
predict or determine whether a first user of a first user device is able to hear a second user of a second user device directly,
enable the first user device to reproduce audio captured by the second user device while the first user device reproduces audio captured by a third user device if the first user is predicted or determined not to be able to hear the second user directly or prevent that the first user device reproduces audio captured by the second user device while the first user device reproduces audio captured by the third user device if the first user is predicted or determined to be able to hear the second user directly.

2. An audio conferencing facilitating device as claimed in claim 1, wherein the audio conferencing facilitating device is the first user device.

3. An audio conferencing facilitating device as claimed in claim 2, wherein the at least one processor is configured to prevent that the first user device reproduces audio captured by the second user device by adjusting its processing of received audio packets such that the audio captured by the second user device is not reproduced.

4. An audio conferencing facilitating device as claimed in claim 2, wherein the at least one processor is configured to prevent that the first user device reproduces audio captured by the second user device by instructing a central audio system or the second user device to prevent that the first user device reproduces audio captured by the second user device.

5. An audio conferencing facilitating device as claimed in claim 1, wherein the audio conferencing facilitating device is the second user device or a central audio system.

6. An audio conferencing facilitating device as claimed in claim 5, wherein the at least one processor is configured to prevent that the first user device reproduces audio captured by the second user device by sending an instruction over a network to the first user device, the instruction instructing the first user device not to reproduce audio captured by the second user device.

7. An audio conferencing facilitating device as claimed in claim 5, wherein the at least one processor is configured to prevent that the first user device reproduces audio captured by the second user device by not transmitting audio captured by the second user device to the first user device.

8. An audio conferencing facilitating device as claimed in claim 5, wherein the audio conferencing facilitating device is the central audio system and the at least one processor is configured to mix audio captured by multiple devices in a single stream customized for the first user device and transmit the single stream to the first user device, and wherein the at least one processor is configured to prevent that the first user device reproduces audio captured by the second user device by omitting the audio captured by the second user device from the single stream transmitted to the first user device.

9. An audio conferencing facilitating device as claimed in claim 1, wherein the at least one processor is configured to:
receive audio captured by a third user device,
determine whether the audio captured by the third user device comprises first audio information originating from a same source as second audio information comprised in the audio captured by the second user device, and
remove the second audio information from the audio captured by the second user device or remove the first audio information from the audio captured by the third user device if the first audio information and the second audio information are determined to originate from the same source.

10. An audio conferencing facilitating device as claimed in claim 1, wherein the at least one processor is configured to:
obtain proximity and/or location data, the proximity and/or location data being indicative of a proximity of the first user device to at least the second user device and/or indicative of at least a location of the first user device and a location of the second user device, and
predict based on the proximity and/or location data whether the first user of the first user device is able to hear the second user of the second user device directly.

11. An audio conferencing system comprising the audio conferencing facilitating device of claim 1.

12. An audio conferencing system as claimed in claim 11, wherein the audio conferencing facilitating device is a central audio system and the audio conferencing system further comprises the first user device, the second user device, and the third user device.

13. An audio conferencing system as claimed in claim 11, wherein the audio conferencing facilitating device is one of the first user device and the second user device and the audio conferencing system further comprises the other one of the first user device and the second user device and further comprises the third user device.

14. An audio conferencing system as claimed in claim 11, wherein the at least one processor of the audio conferencing device or at least one further processor of the audio conferencing system is configured to:
predict or determine whether the first user of the first user device is able to hear a third user of the third user device directly, and
if the first user is predicted or determined not to be able to hear the third user directly, enable the first user device to reproduce audio captured by the second user device and audio captured by the third user device if the first user is predicted or determined not to be able to hear the second user directly or prevent that the first user device reproduces audio captured by the second user device while the first user device reproduces audio captured by the third user device if the first user is predicted or determined to be able to hear the second user directly.

15. A method of facilitating audio conferencing, the method comprising:
predicting or determining whether a first user of a first user device is able to hear a second user of a second user device directly; and
enabling the first user device to reproduce audio captured by the second user device while the first user device reproduces audio captured by a third user device if the first user is predicted or determined not to be able to hear the second user directly or preventing that the first user device reproduces audio captured by the second user device while the first user device reproduces audio captured by the third user device if the first user is predicted or determined to be able to hear the second user directly.

16. A computer program or suite of computer programs comprising at least one software code portion or a computer program product storing at least one software code portion, the software code portion, when run on a computer system, being configured for performing the method of claim 15.
